(19) United States
(12) Patent Application Publication
(10) Pub. No.: US 2024/0155523 A1
(43) Pub. Date: May 9, 2024

(54) METHOD AND APPARATUS FOR SUPPORTING TIME SYNCHRONIZATION

(71) Applicant: Samsung Electronics Co., Ltd., Gyeonggi-do (KR)

(72) Inventor: Sangjun MOON, Gyeonggi-do (KR)

(21) Appl. No.: 18/501,178

(22) Filed: Nov. 3, 2023

(30) Foreign Application Priority Data
Nov. 3, 2022 (KR) 10-2022-0144919

(51) Int. Cl. H04W 56/00

(52) U.S. Cl. CPC H04W 56/003

(57) ABSTRACT

The disclosure relates to 5G or 6G communication systems to support higher data rates. Disclosed is a method performed by a TS CTSF in a wireless communication system, including receiving, from an AF, a first request message for time synchronization including a first time synchronization error budget for a UE, in response to receiving the first request message from the AF, transmitting to a UDM, a second request message for time synchronization subscription data of the UE, receiving, from the UDM, the time synchronization subscription data of the UE including a second time synchronization error budget for the UE, determining a third time synchronization error budget based on the first time synchronization error budget and the second time synchronization error budget, and transmitting, to a PCF, a third request message for time synchronization including the third time synchronization error budget.

### CROSS-REFERENCE TO RELATED APPLICATION(S)

This application is based on and claims priority under 35 U.S.C. § 119 to Korean Patent Application No. 10-2022-0144919, filed on Nov. 3, 2022, in the Korean Intellectual Property Office, the disclosure of which is incorporated herein by reference in its entirety.

### BACKGROUND

### 1. Field

The disclosure relates generally to a method of providing time synchronization between wireless terminals through a wireless communication network, and more particularly, to a method of supporting timing resiliency that provides the stable time synchronization between the wireless terminals.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

For applications such as smart grids, accurate time synchronization between UEs is required. In this case, time synchronization between UEs can utilize a GNSS using satellite signals. However, if GNSS is unavailable even for a moment, problems may occur as accurate time synchronization between UEs cannot be maintained.

The conventional art is deficient in handling a problem occurring with a time synchronization method provided by the third generation partnership project (3GPP) 5G system (5GS), however. Thus, there is a need in the art for a method for handling such a problem to improve the wireless communication network.

### SUMMARY

The disclosure is provided to address at least the above-mentioned problems and/or disadvantages and to provide at least the advantages described below.

An aspect of the disclosure is to provide a method of providing time synchronization between wireless terminals, in which a problem is immediately notified to the terminal or application and the time synchronization method is replaced with a new method using other means such as a global navigation satellite system (GNSS).

An aspect of the disclosure is to provide a method of providing time synchronization between wireless terminals through a 3GPP 5GS based on UE subscription or reference to subscriber information in case of a request of an application function, to avoid confusion on which method to follow when both methods coexist.

An aspect of the disclosure is to provide time synchronization based on UE subscription or on reference to subscriber information in case of a request of an application function, wherein a priority indication is included to avoid confusion in handling cases where the criteria of the two methods are different.

In accordance with an aspect of the disclosure, a method performed by a time sensitive communication and time synchronization function (TSCTSF) in a wireless communication system is provided, including receiving, from an application function (AF), a first request message for time synchronization including a first time synchronization error budget for a UE, in response to receiving the first request message from the AF, transmitting to a united data management (UDM), a second request message for time synchronization subscription data of the UE, receiving, from the UDM, the time synchronization subscription data of the UE including a second time synchronization error budget for the UE, determining a third time synchronization error budget based on the first time synchronization error budget and the second time synchronization error budget, and transmitting, to a policy control function (PCF), a third request message for time synchronization including the third time synchronization error budget.

In accordance with an aspect of the disclosure, a TSCTSF includes a transceiver, and a controller operably coupled with the transceiver and configured to receive, from an AF, a first request message for time synchronization including a first time synchronization error budget for a UE, in response to receiving the first request message from the AF, transmit to a UDM, a second request message for time synchronization subscription data of the UE, receive, from the UDM, the time synchronization subscription data of the UE including a second time synchronization error budget for the UE, determine a third time synchronization error budget based on the first time synchronization error budget and the second time synchronization error budget, and transmit, to a PCF, a third request message for time synchronization including the third synchronization error budget.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates when the 5GC provides a synchronization information service to a UE through the AS with reference to subscriber information, according to an embodiment;

FIG. 2 illustrates when the 5GC provides a synchronization information service to a UE through the AS at a request of the AF, according to an embodiment;

FIG. 3 illustrates a scheme of handling when a subscriber information-based 5GS sync method and an AF request-based 5GS sync method are applied simultaneously, according to an embodiment;

FIG. 4 illustrates a scheme for setting a priority between the subscriber information-based 5GS sync method and the AF request-based 5GS sync method, according to an embodiment;

FIGS. 5A and 5B illustrate a scheme for the AMF to determine whether to refer to subscriber information or AF request according to a priority when the priority is specified by operator settings, according to an embodiment;

FIGS. 6A and 6B illustrate a scheme for the AMF to determine whether to refer to subscriber information or AF request according to a priority when a priority parameter is included in subscription data, according to an embodiment;

FIGS. 7A and 7B illustrate a scheme for the AMF to determine whether to refer to subscriber information or AF request according to a priority when the priority is specified by AF provided parameters, according to an embodiment;

FIGS. 8A and 8B illustrate a scheme for the TSCTSF to determine whether to refer to subscriber information or AF request according to a priority when the priority is specified by operator settings, according to an embodiment;

FIGS. 9A and 9B illustrate a scheme for the TSCTSF to determine whether to refer to subscriber information or AF request according to a priority when a priority parameter is included in subscription data, according to an embodiment;

FIGS. 10A and 10B illustrate a scheme for the TSCTSF to determine whether to refer to subscriber information or AF request according to a priority when the priority is specified by AF provided parameters, according to an embodiment;

FIGS. 11A and 11B illustrate a scheme for the PCF to determine whether to refer to subscriber information or AF request according to a priority when the priority is specified by operator settings, according to an embodiment;

FIGS. 12A and 12B illustrates a scheme for the PCF to determine whether to refer to subscriber information or AF request according to a priority when a priority parameter is included in subscription data, according to an embodiment;

FIGS. 13A and 13B illustrate a scheme for the PCF to determine whether to refer to subscriber information or AF request according to a priority when the priority is specified by AF provided parameters, according to an embodiment;

FIG. 14 illustrates the structure of a UE, according to an embodiment; and

FIG. 15 illustrates the structure of a node, according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

In the drawings, some elements are exaggerated, omitted, or only briefly outlined, and the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various manners. The embodiments are provided only to complete the disclosure and to fully inform the scope of the disclosure to those skilled in the art to which the disclosure pertains.

The elements included in the disclosure are expressed in a singular or plural form according to the embodiment. However, the singular or plural expression is appropriately selected for ease of description according to the situation, and the disclosure is not limited by a single element or plural elements. Those elements described in a plural form may be configured as a single element, and those elements described in a singular form may be configured as plural elements.

The terms described below are defined in consideration of their functions in the disclosure, and may vary depending on the intention of the user, the operator, or the custom. Hence, their meanings should be determined based on the overall contents of the specification.

Those terms used in the following description for identifying an access node and for indicating a network entity, a message, an interface between network entities, and various identification information is illustrated for ease of description. Accordingly, the disclosure is not limited by the terms to be described herein, and other terms referring to objects having an equivalent technical meaning may be used.

For convenience of description, the disclosure uses terms and names defined in 5GS and NR standards, which are the latest standards defined by the 3GPP organization among communication standards that currently exist. However, the disclosure is not limited by the above terms and may be equally applied to wireless communication networks conforming to other standards. In particular, the disclosure is applicable to 3GPP 5GS/NR.

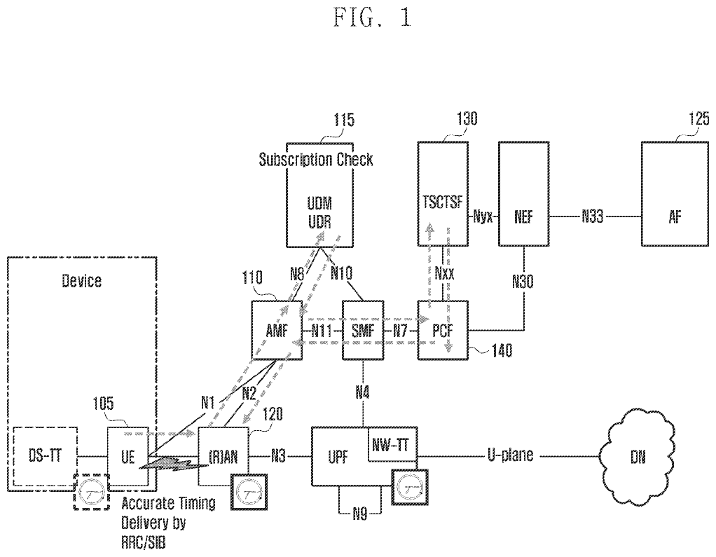

FIG. 1 illustrates when the 5GC provides a synchronization information service to a UE through the AS with reference to subscriber information, according to an embodiment In FIG. 1, the UE 105 transmits a registration request to the AMF of the 5GS. The AMF 110 requests subscription information from the UDM 115. As part of the subscriber information, the UDM 115 stores information that enables the UE to support access stratum (AS) synchronization information service among the 5GS synchronization services and informs the AMF 110 of this. An accuracy requirement mapped to a synchronization error budget may be delivered. A time validity condition for providing the synchronization information service and a coverage condition for providing the synchronization information service may be included. The AMF 110 aggregates these conditions to determine whether the corresponding UE 105 can receive 5GS synchronization. If confirmed, the AMF 110 delivers a configuration message to the RAN 120 to provide AS synchronization information based on this information. According to this configuration, the RAN 120 broadcasts an SIB to deliver time synchronization information to the UE 105 or delivers time synchronization information to the UE 105 through radio resource control (RRC) signaling. In this case, the TSCTSF can manage 5GS synchronization capabilities for timing resiliency. To this end, the AMF 110 may transmit the current synchronization configuration to the TSCTSF 130 via the PCF 140.

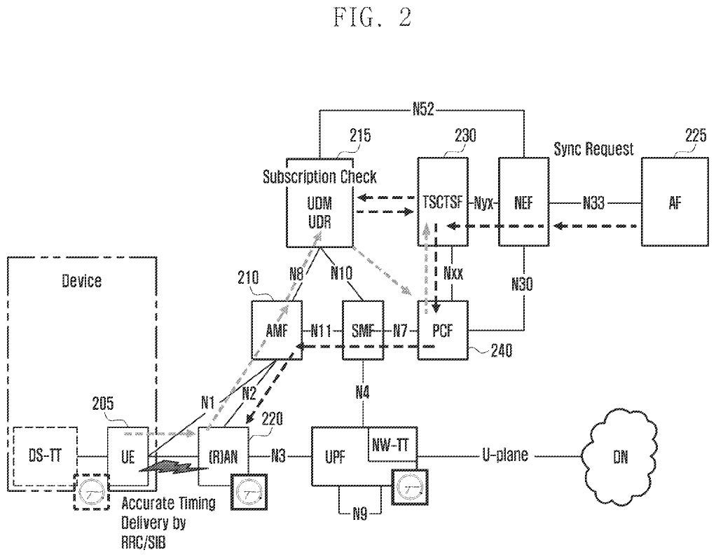

FIG. 2 illustrates when the 5GC provides a synchronization information service to a UE through the AS at a request of the AF, according to an embodiment.

In FIG. 2, the AF 225 transmits a request to the TSCTSF 230 via the NEF 235 to provide an AS synchronization information service among 5GS synchronization services to specific UEs. This request may include target UEs. This request may include an accuracy requirement, a time validity condition to provide a synchronization information service, and a coverage condition to provide a synchronization information service. The TSCTSF 230 checks subscriber information in the UDM 215 and determines whether the UE 205 can receive a synchronization information service through the AS based on the AF request. If the corresponding UE 205 is not registered yet, only a subscription may be made so as to be notified when the UE 205 is registered. When the corresponding UE 205 is registered, this information is notified to the TSCTSF 230 through the PCF 240 or directly to the TSCTSF 230. Upon receiving this notification, the TSCTSF 230 checks the subscriber information in the UDM 215 and determines whether this UE 205 can receive a synchronization information service through the AS based on the AF request. The TSCTSF 230 forwards the request received from the AF 225 to the AMF 210 via the PCF 240. The AMF 210 delivers a configuration message to the RAN 220 to provide AS synchronization information based on this information. According to this configuration, the RAN broadcasts an SIB to deliver time synchronization information to the UE or delivers time synchronization information to the UE through RRC (radio resource control) signaling.

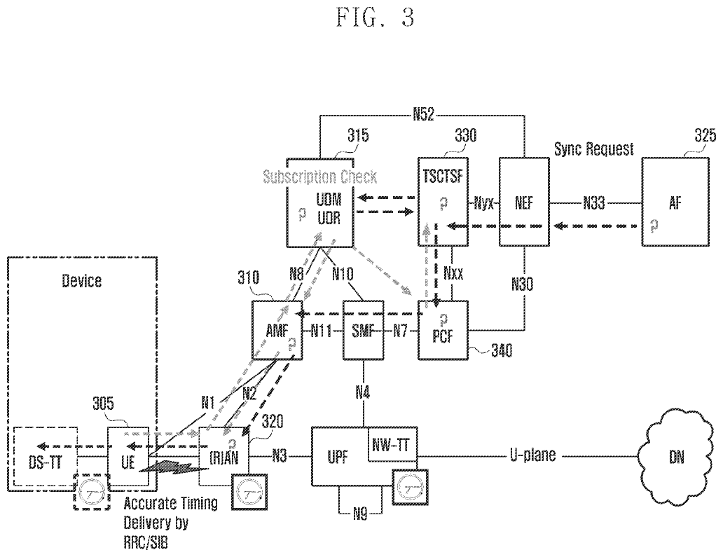

FIG. 3 illustrates a scheme of handling when a subscriber information-based 5GS sync method and an AF 325 request-based 5GS sync method are applied simultaneously, according to an embodiment. Based on UE 305 subscription information, the UDM 315 owns information configured to support an AS synchronization information service, and the AMF 310 can identify this. The request transmitted at this time may include an accuracy requirement. This request may include a time validity condition for providing a synchronization information service and may also include a coverage condition for providing a synchronization information service. At the same time, the AF 325 transmits a request to the TSCTSF 330 via the NEF to provide an AS synchronization information service among 5GS synchronization services to specific UEs. This request may include target UEs, an accuracy requirement a time validity condition to provide a synchronization information service, and a coverage condition to provide a synchronization information service. If an access stratum time distribution (ASTI) request based on UE subscriber information and an ASTI request based on the AF 325 request are applied simultaneously, confusion may arise as to which request the 5GS should follow. For example, these requests can both arrive at the AMF 310. In this case, the AMF 310 cannot determine which request to follow. Also, these two pieces of information may be gathered at the TSCTSF 330. In this case, the TSCTSF 330 cannot determine which information to follow. These two pieces of information may be gathered at the PCF. In this case, the PCF cannot determine which information to follow.

To solve this, a priority can be set and used. The priority setting method may be based on operator settings, UE subscription parameters, or AF provided parameters. This priority is combined with the conditions of the ASTI request to execute actual operation.

As shown in Table 1 below, an accuracy requirement (high precedence) set to “H (high)” may have priority over an accuracy requirement (low precedence). That is, if the high precedence accuracy requirement is H (high) and the low precedence accuracy requirement is L (low) or H (high), the overall accuracy requirement becomes H (high); if the high precedence accuracy requirement is L (low) and the low precedence accuracy requirement is L (low) or H (high), the overall accuracy requirement becomes L (low) or “optionally high”. The priority information may include information indicating whether an accuracy requirement can be set to “optionally high”. Referring to cases 3 and 6 in Table 1 below, when an accuracy requirement is set to “optionally high”, this accuracy requirement may become H (high) only if the 5GS capability supports H (high). That is, an accuracy requirement may be finally determined based on the 5GS capability. Referring to cases 1, 2, 5 and 7 in the table below, when the overall accuracy requirement is H (high) but the 5GS capability is L (low), the overall accuracy requirement of 5GS synchronization may be recognized as off.

TABLE 1

| | | UDM | AF | 5GS | Example |
|---|---|---|---|---|---|
| Case | Precedence | Accuracy | Accuracy | Cap. | Result |
| 1 | UDM > AF | H | H | L/H | Off/H |
| 2 | UDM > AF | H | L | L/H | Off/H |
| 3 | UDM > AF | L | H | L/H | L/H(opt) |
| 4 | UDM > AF | L | L | L/H | L/L |
| 5 | UDM < AF | H | H | L/H | Off/H |
| 6 | UDM < AF | H | L | L/H | L/H(opt) |
| 7 | UDM < AF | L | H | L/H | Off/H |
| 8 | UDM < AF | L | L | L/H | L/L |

As shown in Table 2 below, a high precedence validity time condition set to “on” may have priority over a low precedence validity time condition. That is, if the high precedence validity time condition is “on” and the low precedence validity time condition is “on” or “off”, the overall validity time condition becomes “on”; if the high precedence validity time condition is “off” and the low precedence validity time condition is “on” or “off”, the overall validity time condition becomes “of” or “optionally on”. The priority information can include information indicating whether it can be “optionally on”. As shown in cases 3 and 5 in Table 2 below, when the validity time condition is set to “optionally on”, the overall result can be “on” only if the on-time length is less than or equal to a specific length (e.g., 1 hour). That is, the validity time condition may be finally determined based on a parameter such as “on period length” in Table 2.

TABLE 2

| | | UDM | AF | | |
|---|---|---|---|---|---|
| | | Validity | Validity | On Period | Example |
| Case | Precedence | Time | Time | Length | Result |
| 1 | UDM > AF | On | On | Short/Long | On |
| 2 | UDM > AF | On | Off | Short/Long | On |
| 3 | UDM > AF | Off | On | Short/Long | On(opt)/Off |
| 4 | UDM > AF | Off | Off | Short/Long | Off |
| 5 | UDM < AF | On | Off | Short/Long | On(opt)/Off |
| 6 | UDM < AF | Off | Off | Short/Long | Off |
| 7 | UDM < AF | On | On | Short/Long | On |
| 8 | UDM < AF | Off | On | Short/Long | On |

As shown in Table 3 below, a high precedence coverage condition set to “in” may have priority over a low precedence coverage condition. That is, if the high precedence coverage condition is “in” and the low precedence coverage condition is “in” or “out”, the overall coverage condition becomes “in”; if the high precedence coverage condition is “out” and the low precedence coverage condition is “in” or “out”, the overall coverage condition becomes “out” or “optionally in”. The priority information can include information indicating whether it can be “optionally in”. As in cases 3 and 5 in Table 3 below, when the coverage condition is set to “optionally in”, the overall result can be “in” only if the in-coverage size is less than or equal to a specific size (e.g., 3 cells). That is, the coverage condition may be finally determined based on a parameter such as “in-coverage size” in Table 3.

TABLE 3

| | | UDM | AF | In-Coverage | Example |
|---|---|---|---|---|---|
| Case | Precedence | Coverage | Coverage | Size | Result |
| 1 | UDM > AF | In | In | Small/Large | In |
| 2 | UDM > AF | In | Out | Small/Large | In |
| 3 | UDM > AF | Out | In | Small/Large | In(opt)/Out |
| 4 | UDM > AF | Out | Out | Small/Large | Out |
| 5 | UDM < AF | In | Out | Small/Large | In(opt)/Out |
| 6 | UDM < AF | Out | Out | Small/Large | Out |
| 7 | UDM < AF | In | In | Small/Large | In |
| 8 | UDM < AF | Out | In | Small/Large | In |

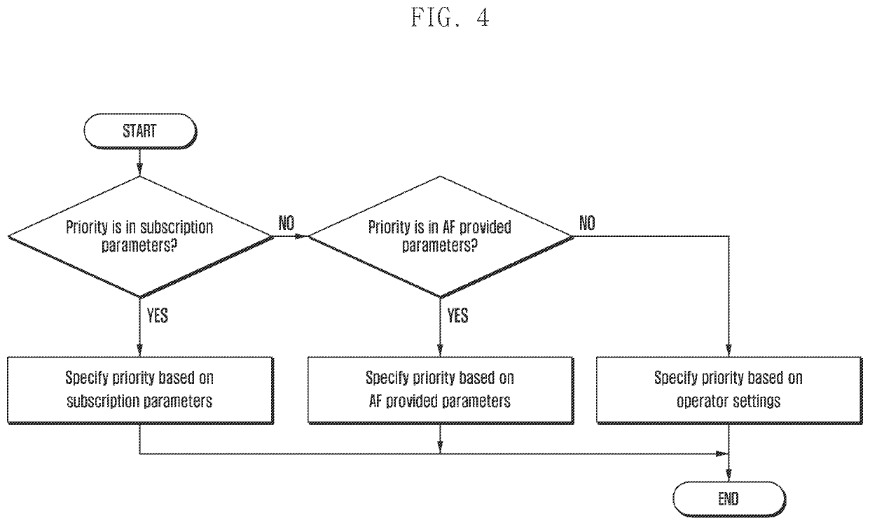

FIG. 4 illustrates a scheme for setting a priority between the subscriber information-based 5GS sync method and the AF request-based 5GS sync method, according to an embodiment. If in step 405 priority information is present in the subscription parameters, then in step 410 the priority is specified based on the subscription parameters of the UE. If it is determined in step 415 that there is no priority information in the subscription parameters and priority information is present in the AF provided parameters, then in step 420, priority may be specified based on the AF provided parameters. If there is no priority information in the subscription parameters or in the AF provided parameters, then in step 425, the priority may be specified based on the operator settings.

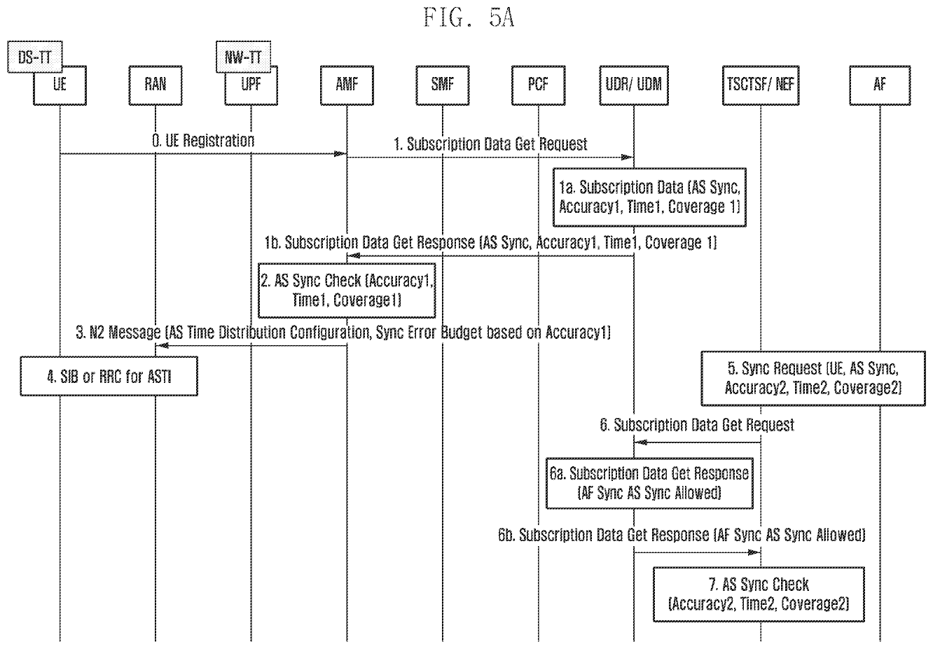

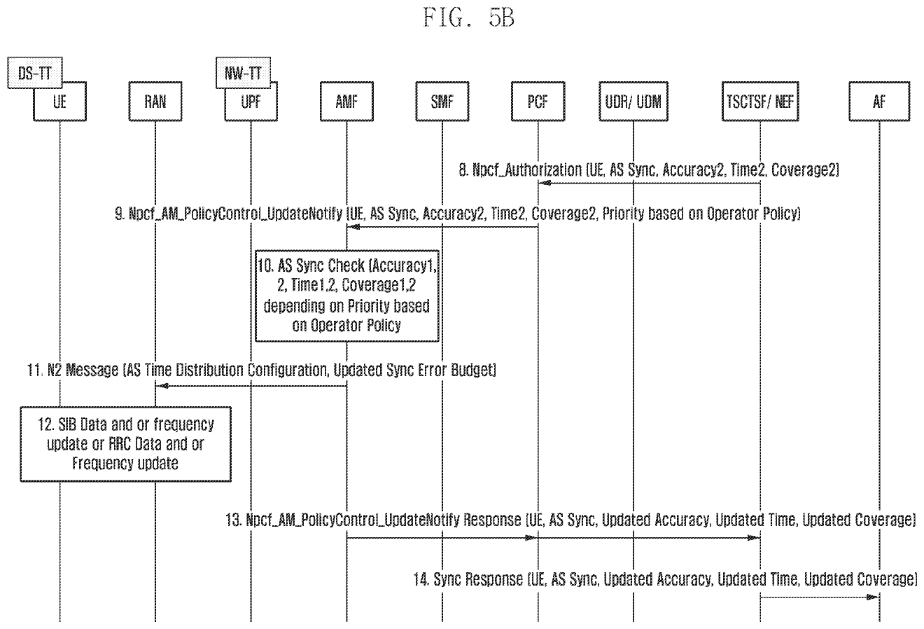

FIGS. 5A and 5B illustrate a scheme for the AMF to determine whether to refer to subscriber information or AF request according to a priority when the priority is specified by operator settings, according to an embodiment.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, and coverage1 information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a Tracking Area (TA) list or cell list. The case where a coverage condition is satisfied may be expressed as “in”, and when a coverage condition is not satisfied may be expressed as “out”. If there is a change in the conditions of UDM data, this is notified to the AMF, and the procedure is repeated from step 1b.

In step 1b, the AMF receives subscription data from the UDM. AS Sync, accuracy1, time1, and coverage1 information may be included.

In step 2, the AMF may check AS sync conditions by checking accuracy1, time1, and coverage1 information received in step 1b. The AMF may derive a synchronization error budget that is mapped to accuracy1. The AMF determines whether the 5GS can currently support it. Also, the AMF determines whether the current time satisfies the validity time condition of time1. The AMF determines whether the location of the UE satisfies a coverage1 condition.

In step 3, the AMF may request AS sync by transmitting an N2 message to the RAN. An AS time distribution configuration and synchronization error budget based on accuracy1 may be included.

In step 4, the RAN can support time synchronization between UEs by broadcasting an SIB containing time information or by RRC (radio resource control) signaling including time information. To this end, the RAN may adjust the periodicity of SIB transmission or the periodicity of timing advance measurement using RRC.

In step 5, the AF may request, through the NEF, the TSCTSF to provide a 5GS synchronization service. This request may include UE, AS sync, accuracy2, time2, and coverage2 information. UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”.

In step 6, the TSCTSF requests the UDM to transmit subscription data for the corresponding UE.

In step 6a, the UDM may include AF sync AS sync allowed information in the response, which indicates whether the corresponding UE can receive the AS sync service based on an AF request.

In step 6b, the TSCTSF receives subscription data for the corresponding UE from the UDM. The subscription data may include AF sync AS sync allowed information.

In step 7, after determining whether the AS sync service is available In step 6b, the TSCTSF may check AS sync conditions by checking accuracy2, time2, and coverage2 received In step 5. The TSCTSF may derive a synchronization error budget that is mapped to accuracy2. The TSCTSF determines whether the 5GS can currently support the TSCTSF and whether the current time satisfies the validity time condition of time2. The TSCTSF determines whether the location of the UE satisfies a coverage2 condition.

In step 8, the TSCTSF transmits a 5GS sync request to the PCF. The 5GS sync request may include UE, AS sync, accuracy2, time2, and coverage2 information.

In step 9, the PCF forwards the 5GS sync request to the AMF. The 5GS sync request may include UE, AS sync, accuracy2, time2, coverage2, and priority information based on operator policy, which is set by the operator and represents the scheme for handling the case where the subscriber information-based 5GS sync method and the AF request-based 5GS sync method are applied simultaneously.

In step 10, the AMF checks accuracy1 and 2, time1 and 2, and coverage1 and 2 information according to priority based on operator policy to derive updated accuracy, updated time, and updated coverage information as described in FIG. 3, and checks AS sync conditions based on this. The AMF may derive a synchronization error budget that is mapped to updated accuracy. The AMF determines whether the 5GS can currently support the AMF and whether the current time satisfies the validity time condition of updated time. The AMF determines whether the location of the UE satisfies an updated coverage condition. In this case, priority based on operator policy may be undelivered from the PCF In step 9 but may have been set in advance by the operator in the AMF.

In step 11, the AMF may request AS sync by transmitting an N2 message to the RAN. The N2 message may include AS time distribution configuration and updated synchronization error budget based on accuracy.

In step 12, the RAN can support time synchronization between UEs by broadcasting an SIB containing time information or by RRC (radio resource control) signaling including time information according to the updated synchronization error budget based on Accuracy. To this end, the RAN may update the periodicity of SIB transmission or the periodicity of timing advance measurement using RRC.

In step 13, the AMF transmits the applied 5GS sync-related information to the TSCTSF via the PCF. The transmitted 5GS Sync-related information may include UE, AS sync, updated accuracy, updated time, and updated coverage information. If the information does not match the originally requested requirements, steps 8 to 12 may be repeated to turn off 5GS sync.

In step 14, the TSCTSF forwards the applied 5GS sync-related information to the AF via the NEF. The forwarded 5GS sync-related information may include UE, AS sync, updated accuracy, updated time, and updated coverage information. If the information does not match the originally requested requirements, steps 5 to 12 may be repeated to turn off 5GS sync.

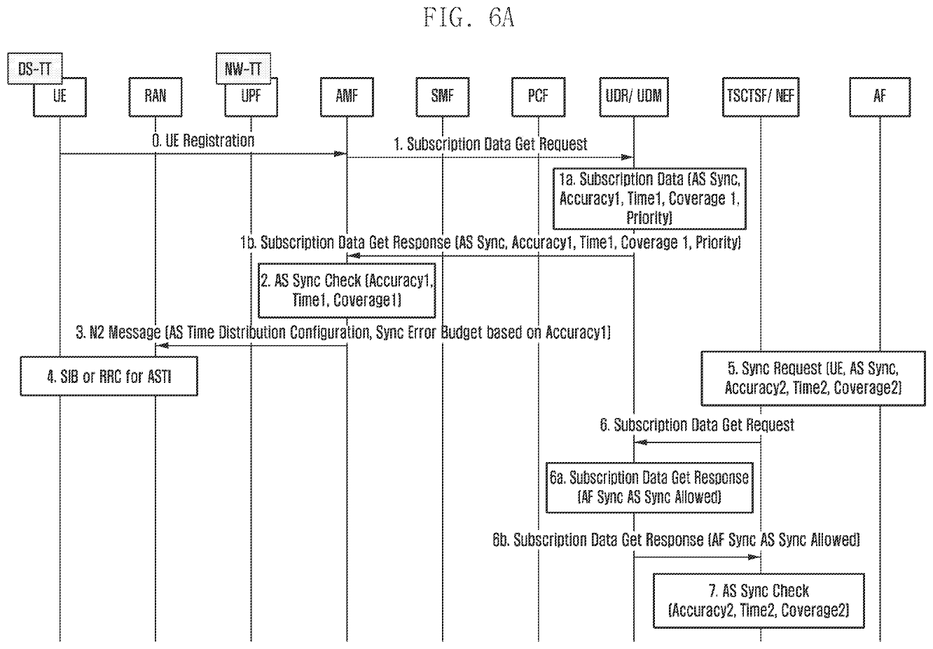

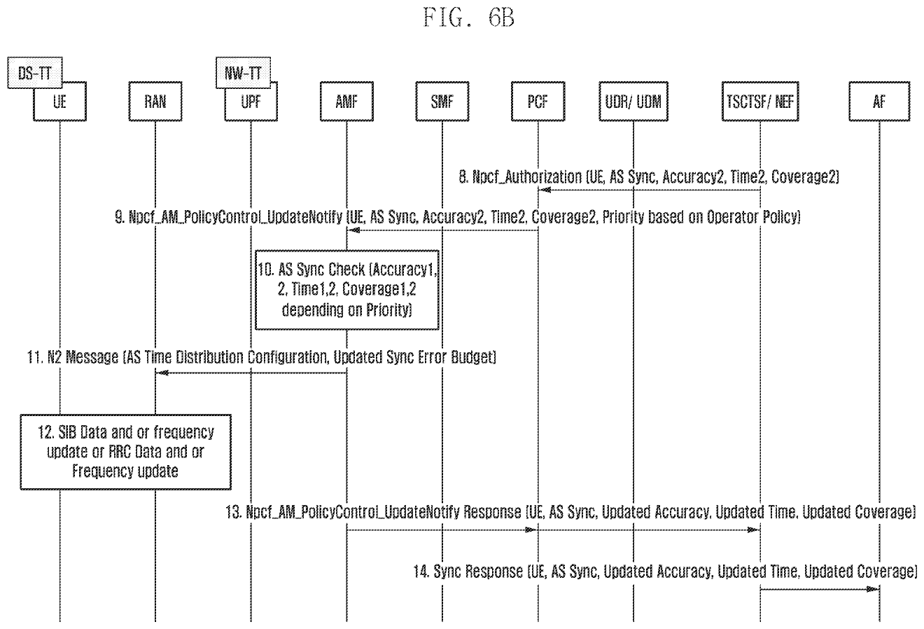

FIGS. 6A and 6B illustrate a scheme for the AMF to determine whether to refer to subscriber information or AF request according to a priority when a priority parameter is included in subscription data, according to an embodiment.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, coverage1, and priority information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”. Priority represents the scheme for handling the case where the subscriber information-based 5GS sync method and the AF request-based 5GS sync method are applied simultaneously. If there is a change in the conditions of UDM data, this is notified to the AMF, and the procedure is repeated from step 1b.

In step 1b, the AMF receives subscription data from the UDM. AS sync, accuracy1, time1, coverage1, and priority information may be included.

In step 2, the AMF may check AS sync conditions by checking accuracy1, time1, and coverage1 received In step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. An AS time distribution configuration and synchronization error budget based on accuracy1 may be included.

In step 4, the RAN can support time synchronization between UEs by broadcasting a system information block (SIB) containing time information or by radio resource control (RRC) signaling including time information. To this end, the RAN may adjust the periodicity of SIB transmission or the periodicity of timing advance measurement using RRC.

In step 5, the AF may request, through the NEF, the TSCTSF to provide a 5GS synchronization service. This request may include UE, AS sync, accuracy2, time2, and coverage2 information. UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. Coverage2 represents a coverage condition to support AS sync and is expressed as a TA list or cell list. The case where a coverage condition is satisfied may be expressed as “in”, and when a coverage condition is not satisfied may be expressed as “out”.

In step 6, the TSCTSF requests the UDM to transmit subscription data for the corresponding UE.

In step 6a, the UDM may include AF sync AS sync allowed information in the response. AF sync AS sync allowed indicates whether the corresponding UE can receive the AS sync service based on an AF request.

In step 6b, the TSCTSF receives subscription data for the corresponding UE from the UDM. The subscription data may include AF sync AS sync allowed information.

In step 7, after determining whether the AS sync service is available In step 6b, the TSCTSF may check AS sync conditions by checking accuracy2, time2, and coverage2 information received In step 5. The TSCTSF may derive a synchronization error budget that is mapped to accuracy2. The TSCTSF determines whether the 5GS can currently support the TSCTSF and whether the current time satisfies the validity time condition of time2. The TSCTSF determines whether the location of the UE satisfies a coverage2 condition.

In step 8, the TSCTSF transmits a 5GS sync request to the PCF. The transmitted request may include UE, AS sync, accuracy2, time2, and coverage2 information.

In step 9, the PCF forwards the 5GS sync request to the AMF. The transmitted request may include UE, AS sync, accuracy2, time2, and coverage2 information.

In step 10, the AMF checks accuracy1 and 2, time1 and 2, and coverage1 and 2 information according to priority to derive updated accuracy, updated time, and updated coverage information as described in FIG. 3, and checks AS sync conditions based on this. The AMF may derive a synchronization error budget that is mapped to updated accuracy. The AMF determines whether the 5GS can currently support the AMF and whether the current time satisfies the validity time condition of updated time. The AMF determines whether the location of the UE satisfies an updated coverage condition.

In step 11, the AMF may request AS sync by transmitting an N2 message to the RAN. The N2 message may include AS time distribution configuration and updated synchronization error budget based on accuracy.

In step 12, the RAN can support time synchronization between UEs by broadcasting an SIB containing time information or by RRC signaling including time information according to the updated synchronization error budget based on accuracy. To this end, the RAN may update the periodicity of SIB transmission or the periodicity of timing advance measurement using RRC.

In step 13, the AMF transmits the applied 5GS sync-related information to the TSCTSF via the PCF. The 5GS sync-related information may include UE, AS sync, updated accuracy, updated time, and updated coverage. If the information does not match the originally requested requirements, steps 8 to 12 may be repeated to turn off 5GS sync.

In step 14, the TSCTSF forwards the applied 5GS sync-related information to the AF via the NEF. The 5GS sync-related information may include UE, AS Sync, updated accuracy, updated time, and updated coverage information. If the information does not match the originally requested requirements, steps 5 to 12 may be repeated to turn off 5GS sync.

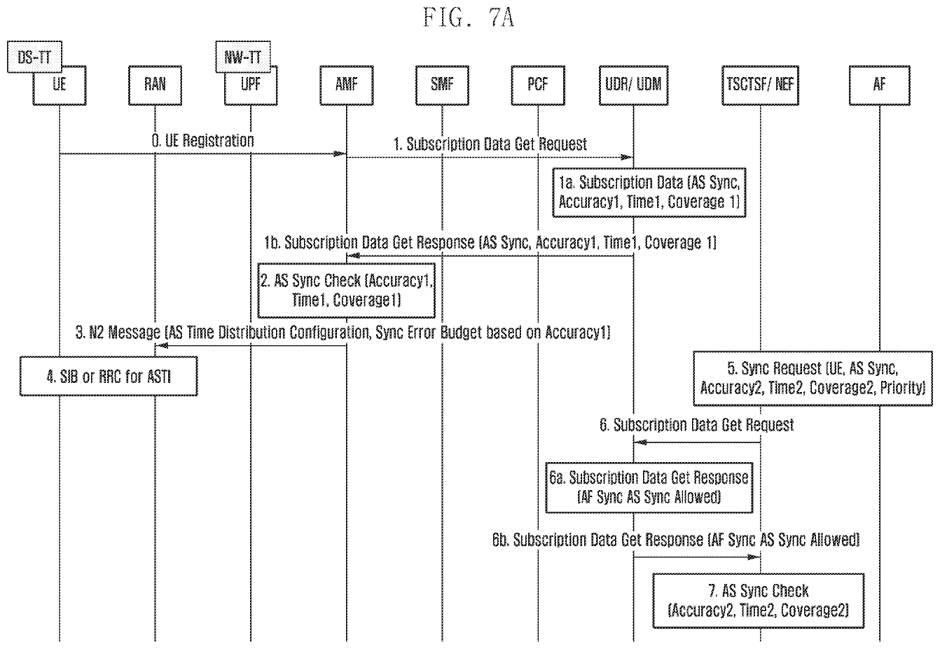

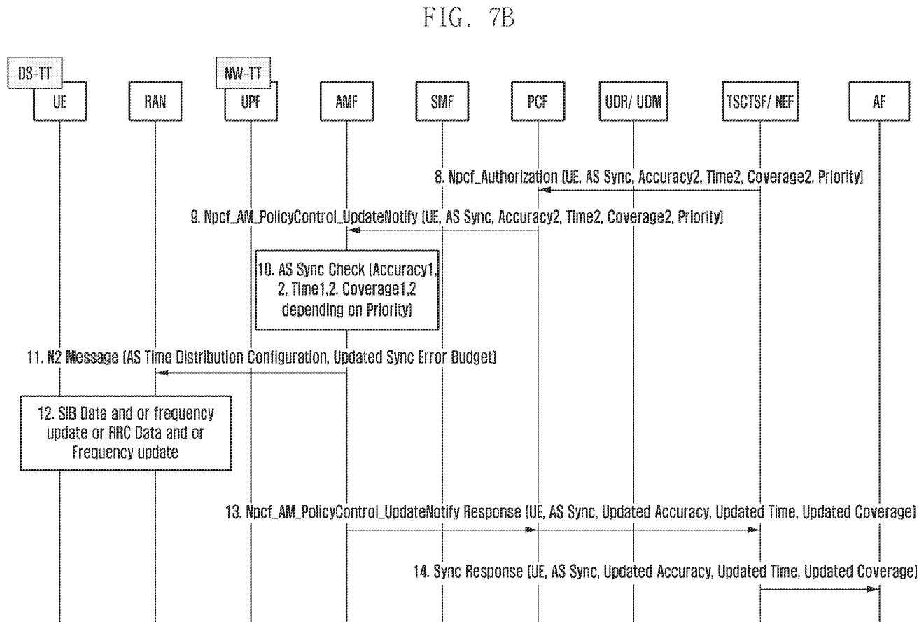

FIGS. 7A and 7B illustrate a scheme for the AMF to determine whether to refer to subscriber information or AF request according to a priority when the priority is specified by AF provided parameters, according to an embodiment.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, and coverage1 information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”.

In step 1b, the AMF receives subscription data from the UDM. The subscription data may include AS Sync, accuracy1, time1, coverage1, and priority information.

In step 2, the AMF may check AS sync conditions by checking accuracy1, time1, and coverage1 received in step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. An AS time distribution configuration and synchronization error budget based on accuracy1 may be included in the N2 message.

In step 4, the RAN can support time synchronization between UEs by broadcasting an SIB containing time information or by RRC (radio resource control) signaling including time information. To this end, the RAN may adjust the periodicity of SIB transmission or the periodicity of timing advance measurement using RRC.

In step 5, the AF may request, through the NEF, the TSCTSF to provide a 5GS synchronization service. This request may include UE, AS sync, accuracy2, time2, coverage2, and priority information. UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”. Priority represents the scheme for handling the case where the subscriber information-based 5GS sync method and the AF request-based 5GS sync method are applied simultaneously.

In step 6, the TSCTSF requests the UDM to transmit subscription data for the corresponding UE.

In step 6a, the UDM may include AF sync AS sync allowed in the response. AF sync AS sync allowed indicates whether the corresponding UE can receive the AS sync service based on an AF request.

In step 6b, the TSCTSF receives subscription data for the corresponding UE from the UDM. The subscription data may include AF sync AS sync allowed information.

In step 7, after determining whether the AS sync service is available In step 6b, the TSCTSF may check AS sync conditions by checking accuracy2, time2, and coverage2 information received In step 5. The TSCTSF may derive a synchronization error budget that is mapped to accuracy2. The TSCTSF determines whether the 5GS can currently support the TSCTSF and whether the current time satisfies the validity time condition of time2. The TSCTSF determines whether the location of the UE satisfies a coverage2 condition.

In step 8, the TSCTSF transmits a 5GS sync request to the PCF. The 5GS sync request may include UE, AS sync, accuracy2, time2, coverage2, and priority information.

In step 9, the PCF forwards the 5GS sync request to the AMF. The 5GS sync request may include UE, AS sync, accuracy2, time2, coverage2, and priority information.

In step 10, the AMF checks accuracy1 and 2, time1 and 2, and coverage1 and 2 information according to Priority to derive updated accuracy, updated time, and updated coverage as described in FIG. 3, and checks AS sync conditions based on this. The AMF may derive an updated synchronization error budget that is mapped to updated accuracy. The AMF determines whether the 5GS can currently support the AMF and whether the current time satisfies the validity time condition of updated time. The AMF determines whether the location of the UE satisfies an updated coverage condition.

In step 11, the AMF may request AS sync by transmitting an N2 message to the RAN. The N2 message may include AS time distribution configuration and updated synchronization error budget based on accuracy.

In step 12, the RAN can support time synchronization between UEs by broadcasting an SIB containing time information or by RRC (radio resource control) signaling including time information according to the updated synchronization error budget based on accuracy. To this end, the RAN may update the periodicity of SIB transmission or the periodicity of timing advance measurement using RRC.

In step 13, the AMF transmits the applied 5GS Sync-related information to the TSCTSF via the PCF. The transmitted message may include UE, AS sync, updated accuracy, updated time, and updated coverage information. If the information does not match the originally requested requirements, steps 8 to 12 may be repeated to turn off 5GS sync.

In step 14, the TSCTSF forwards the applied 5GS Sync-related information to the AF via the NEF. The forwarded message may include UE, AS Sync, updated accuracy, updated time, and updated coverage. If the information does not match the originally requested requirements, steps 5 to 12 may be repeated to turn off 5GS Sync.

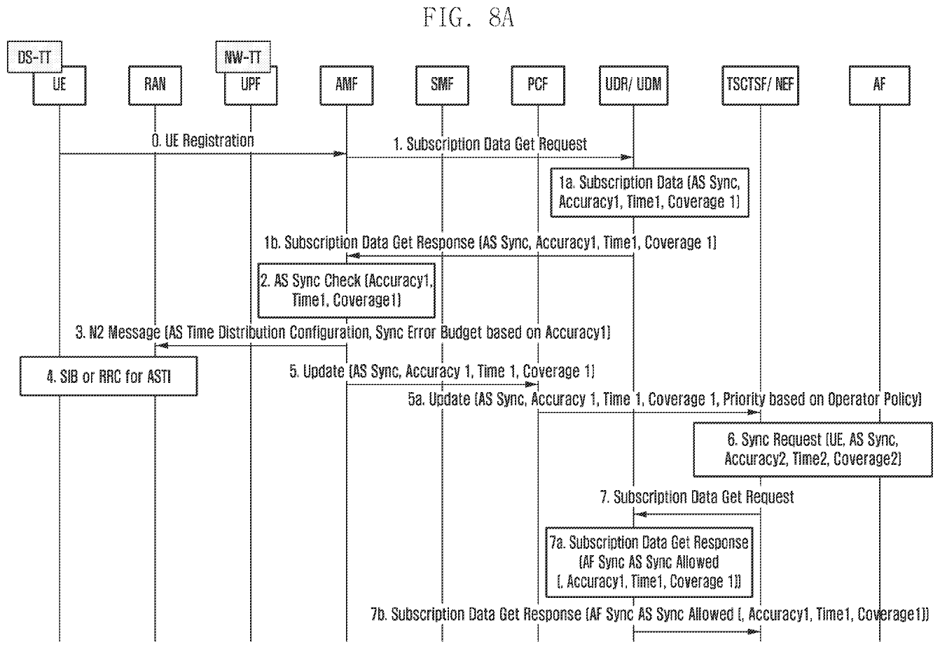

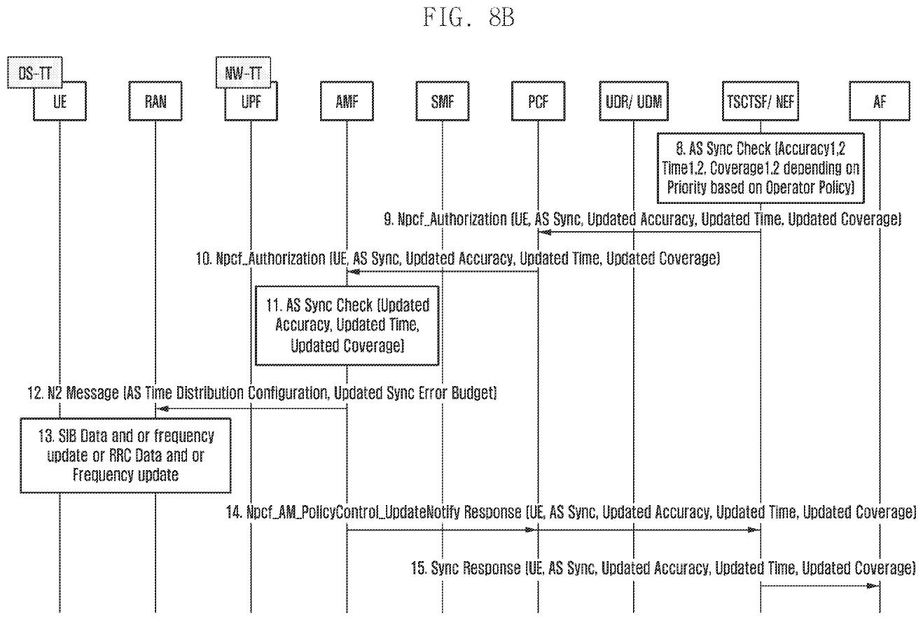

FIGS. 8A and 8B illustrate a scheme for the TSCTSF to determine whether to refer to subscriber information or AF request according to a priority when the priority is specified by operator settings, according to an embodiment.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, and coverage1 information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”. If there is a change in the conditions of UDM data, this is notified to the AMF, and the procedure is repeated from step 1b.

In step 1b, the AMF receives subscription data from the UDM. AS sync, accuracy1, time1, and coverage1 information may be included.

In step 2, the AMF may check AS sync conditions by checking accuracy1, time1, and coverage1 received In step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. Here, AS time distribution configuration and synchronization error budget based on accuracy1 may be included in the N2 message.

In step 4, the RAN can support time synchronization between UEs by broadcasting an SIB containing time information or by RRC (radio resource control) signaling including time information. To this end, the RAN may adjust the periodicity of SIB transmission or the periodicity of timing advance measurement using RRC.

In step 5, the AMF transmits the current 5GS sync information to the PCF. The 5GS sync information may include UE, AS sync, accuracy1, time1, and coverage1 information.

In step 5a, the PCF forwards the current 5GS sync information to the TSCTSF. The 5GS sync information may include AS sync, accuracy1, time1, coverage1, and priority information based on operator policy, which is set by the operator and represents the scheme for handling the case where the subscriber information-based 5GS sync method and the AF request-based 5GS sync method are applied simultaneously.

In step 6, the AF may request, through the NEF, the TSCTSF to provide a 5GS synchronization service. This request may include UE, AS sync, accuracy2, time2, and coverage2 information. UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”.

In step 7, the TSCTSF requests the UDM to transmit subscription data for the corresponding UE.

In step 7a, the UDM may include AF sync AS sync allowed in the response. AF sync AS sync allowed indicates whether the corresponding UE can receive the AS sync service based on an AF request. The UDM may also include accuracy1, time1, and coverage1 information in the response, in which case steps 5 and 5a may be skipped.

In step 7b, the TSCTSF receives subscription data for the corresponding UE from the UDM. The subscription data may include AF sync AS sync allowed. At this time, the subscription data may also include accuracy1, time1, and coverage1 information, in which case steps 5 and 5a may be skipped.

In step 8, after determining whether the AS sync service is available In step 7b, the TSCTSF may check accuracy1 and 2, time1 and 2, and coverage1 and 2 information according to Priority based on Operator Policy to derive accuracy updated accuracy, updated time, and coverage updated coverage as described in FIG. 3, and check AS sync conditions based on this. The TSCTSF may derive an updated synchronization error budget that is mapped to a updated accuracy. The TSCTSF determines whether the 5GS can currently support the TSCTSF and whether the current time satisfies the validity time condition of updated time. The TSCTSF determines whether the location of the UE satisfies an updated coverage condition. In this case, Priority based on Operator Policy may be undelivered from the PCF In step 5a but may have been set in advance by the operator in the TSCTSF.

In step 9, the TSCTSF transmits a 5GS sync request to the PCF. The 5GS sync request may include UE, AS sync, updated accuracy, updated time, and updated coverage information.

In step 10, the PCF forwards the 5GS sync request to the AMF. The 5GS sync request may include UE, AS sync, updated accuracy, updated time, and updated coverage information.

In step 11, the AMF may check AS sync conditions based on updated accuracy, updated time, and updated coverage. The AMF may derive an updated synchronization error budget that is mapped to updated accuracy. The AMF determines whether the 5GS can currently support the AMF and whether the current time satisfies the validity time condition of updated time. The AMF determines whether the location of the UE satisfies an updated coverage condition.

In step 12, the AMF may request AS sync by transmitting an N2 message to the RAN. The N2 message may include AS time distribution configuration and updated synchronization error budget based on accuracy.

In step 13, the RAN can support time synchronization between UEs by broadcasting an SIB containing time information or by RRC (radio resource control) signaling including time information according to the updated synchronization error budget based on accuracy. To this end, the RAN may update the periodicity of SIB transmission or the periodicity of timing advance measurement using RRC.

In step 14, the AMF transmits the applied 5GS Sync-related information to the TSCTSF via the PCF. The 5GS Sync-related information may include UE, AS sync, updated accuracy, updated time, and updated coverage. If the information does not match the originally requested requirements, steps 8 to 12 may be repeated to turn off 5GS Sync.

In step 15, the TSCTSF forwards the applied 5GS Sync-related information to the AF via the NEF. The 5GS Sync-related information may include UE, AS sync, updated accuracy, updated time, and updated coverage. If the information does not match the originally requested requirements, steps 5 to 12 may be repeated to turn off 5GS Sync.

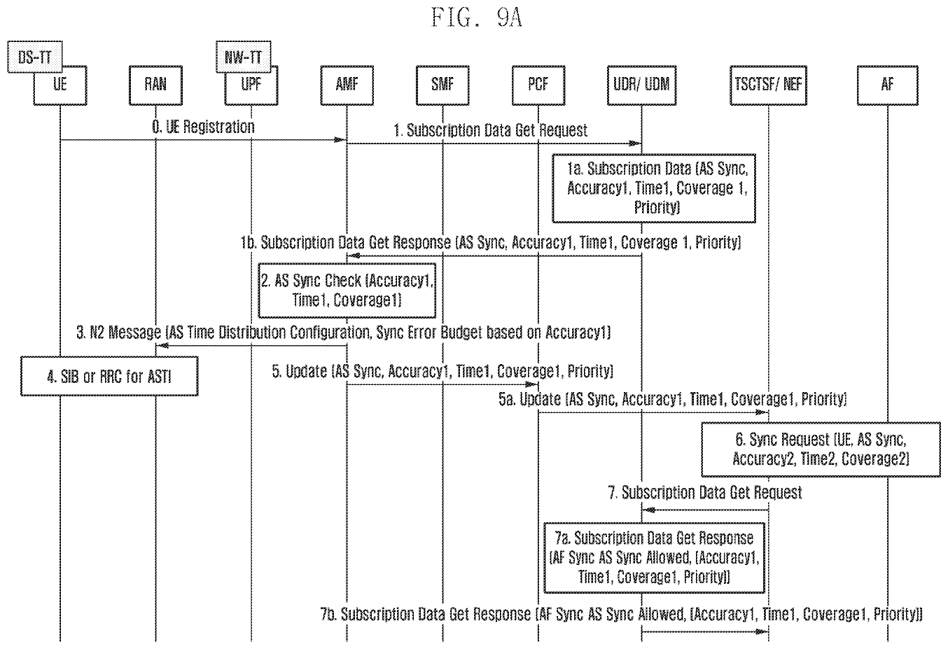

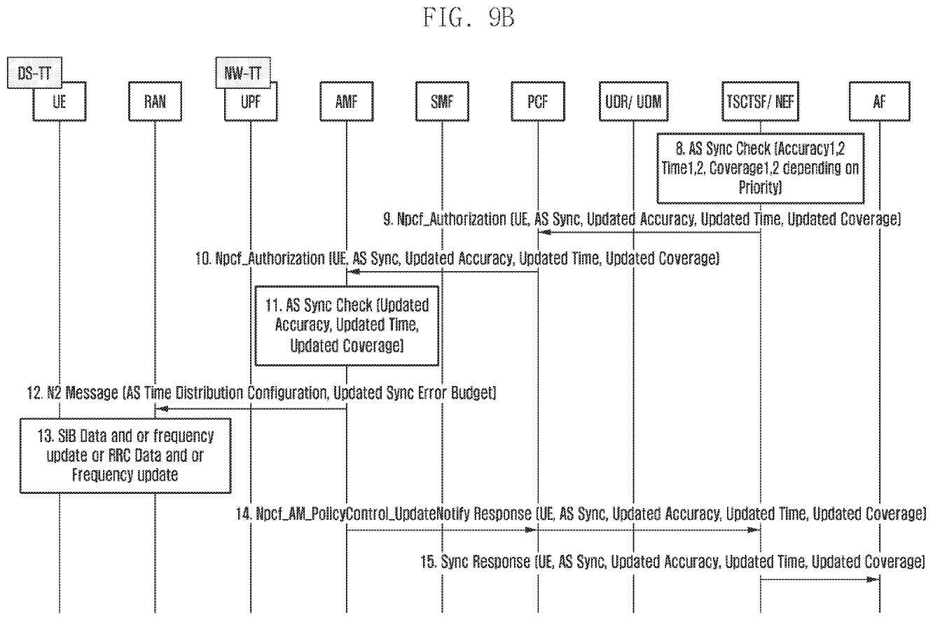

FIGS. 9A and 9B illustrate a scheme for the TSCTSF to determine whether to refer to subscriber information or AF request according to a priority when a priority parameter is included in subscription data, according to an embodiment.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, coverage1, and priority information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”. Priority represents the scheme for handling the case where the subscriber information-based 5GS sync method and the AF request-based 5GS sync method are applied simultaneously. If there is a change in the conditions of UDM data, this is notified to the AMF, and the procedure is repeated from step 1b.

In step 1b, the AMF receives subscription data from the UDM. Here, AS sync, accuracy1, time1, coverage1, and priority information may be included in the subscription data.

In step 2, the AMF may check AS sync conditions by checking accuracy1, time1, and coverage1 received In step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. Here, AS time distribution configuration and synchronization error budget based on accuracy1 may be included.

In step 4, the RAN can support time synchronization between UEs by broadcasting an SIB containing time information or by RRC (radio resource control) signaling including time information. To this end, the RAN may adjust the periodicity of SIB transmission or the periodicity of timing advance measurement using RRC.

In step 5, the AMF transmits the current 5GS sync information to the PCF. The 5GS sync information may include AS sync, accuracy1, time1, coverage1, and priority information.

In step 5a, the PCF forwards the current 5GS sync information to the TSCTSF. The 5GS sync information may include AS sync, accuracy1, time1, coverage1, and priority information.

In step 6, the AF may request, through the NEF, the TSCTSF to provide a 5GS synchronization service. This request may include UE, AS sync, accuracy2, time2, and coverage2 information. UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”.

In step 7, the TSCTSF requests the UDM to transmit subscription data for the corresponding UE.

In step 7a, the UDM may include AF sync AS sync allowed in the response. AF sync AS sync allowed indicates whether the corresponding UE can receive the AS Sync service based on an AF request. At this time, the UDM may also include accuracy1, time1, coverage1, and priority information in the response, in which case steps 5 and 5a may be skipped.

In step 7b, the TSCTSF receives subscription data for the corresponding UE from the UDM. The subscription data may include AF sync AS sync allowed. At this time, the subscription data may also include accuracy1, time1, coverage1, and priority information, in which case steps 5 and 5a may be skipped.

In step 8, after determining whether the AS sync service is available in step 7b, the TSCTSF may check accuracy1 and 2, time1 and 2, and coverage1 and 2 information according to priority to derive updated accuracy, updated time, and updated coverage information as described in FIG. 3, and check AS sync conditions based on this. The TSCTSF may derive an updated synchronization error budget that is mapped to updated accuracy. The TSCTSF determines whether the 5GS can currently support the TSCTSF and whether the current time satisfies the validity time condition of updated time. The TSCTSF determines whether the location of the UE satisfies an updated coverage condition.

In step 9, the TSCTSF transmits a 5GS sync request to the PCF. The 5GS sync request may include UE, AS sync, updated accuracy, updated time, and updated coverage information.

In step 10, the PCF forwards the 5GS sync request to the AMF. The 5GS sync request may include UE, AS sync, updated accuracy, updated time, and updated coverage information.

In step 11, the AMF may check AS sync conditions based on updated accuracy, updated time, and updated coverage information. The AMF may derive an updated synchronization error budget that is mapped to updated accuracy. The AMF determines whether the 5GS can currently support the AMF and whether the current time satisfies the validity time condition of updated time. The AMF determines whether the location of the UE satisfies an updated coverage condition.

In step 12, the AMF may request AS sync by transmitting an N2 message to the RAN. The N2 message may include AS time distribution configuration and updated synchronization error budget based on Accuracy.

In step 13, the RAN can support time synchronization between UEs by broadcasting an SIB containing time information or by RRC (radio resource control) signaling including time information according to the updated synchronization error budget based on accuracy. To this end, the RAN may update the periodicity of SIB transmission or the periodicity of timing advance measurement using RRC.

In step 14, the AMF transmits the applied 5GS Sync-related information to the TSCTSF via the PCF. The 5GS sync-related information may include UE, AS Sync, updated accuracy, updated time, and updated coverage. If the information does not match the originally requested requirements, steps 8 to 12 may be repeated to turn off 5GS Sync.

In step 15, the TSCTSF forwards the applied 5GS Sync-related information to the AF via the NEF. The 5GS Sync-related information may include UE, AS sync, updated accuracy, updated time, and updated coverage information. If the information does not match the originally requested requirements, steps 5 to 12 may be repeated to turn off 5GS Sync.

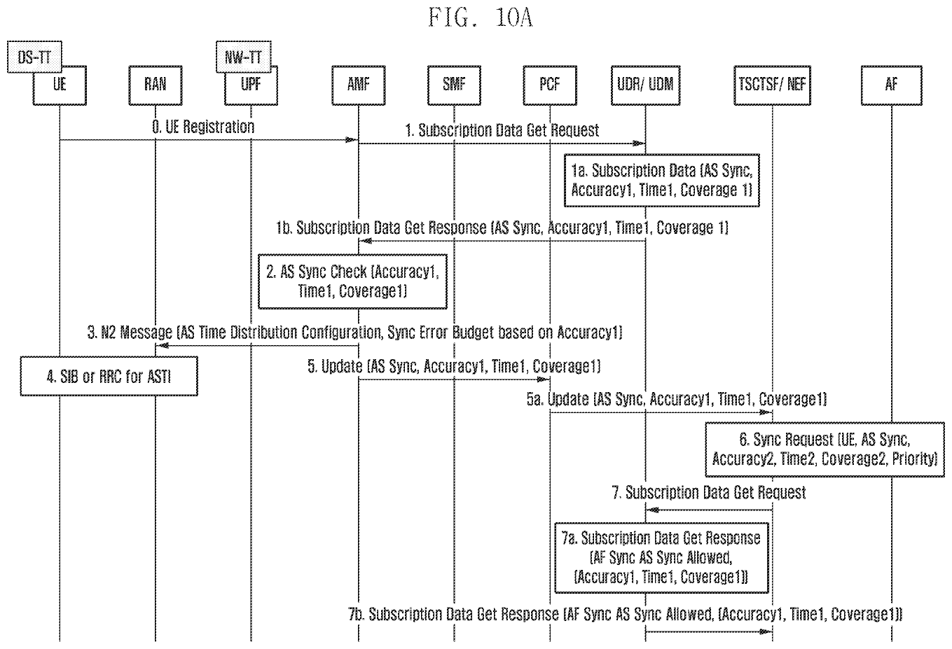

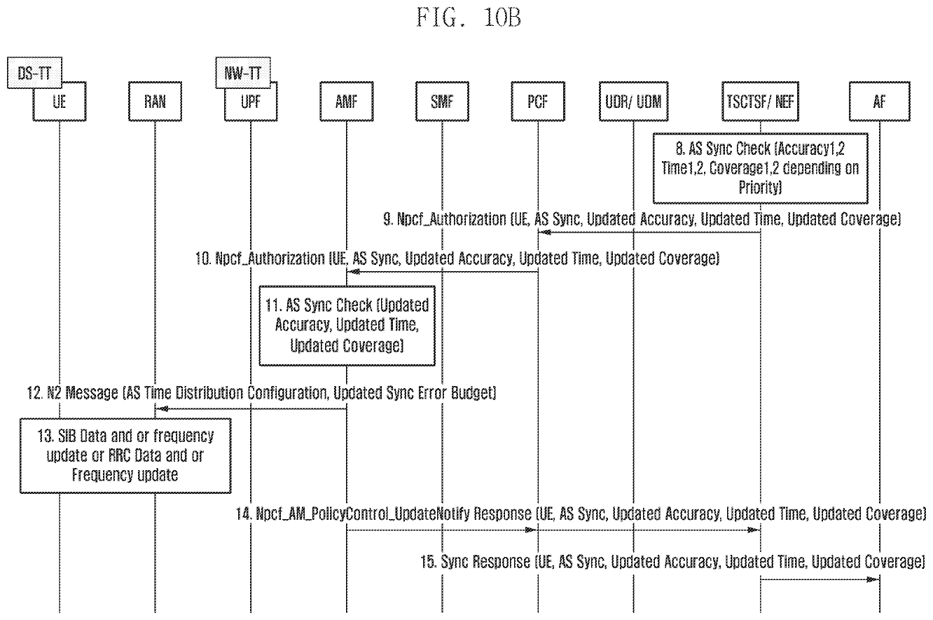

FIGS. 10A and 10B illustrate a scheme for the TSCTSF to determine whether to refer to subscriber information or AF request according to a priority when the priority is specified by AF provided parameters, according to an embodiment.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, and coverage1 information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”. If there is a change in the conditions of UDM data, this is notified to the AMF, and the procedure is repeated from step 1b.

In step 1b, the AMF receives subscription data from the UDM. An AS Sync, accuracy1, time1, and coverage1 information may be included in the subscription data.

In step 2, the AMF may check AS sync conditions by checking accuracy1, time1, and coverage1 information received In step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. Here, AS time distribution configuration and synchronization error budget based on accuracy1 may be included in the N2 message.

In step 4, the RAN can support time synchronization between UEs by broadcasting an SIB containing time information or by RRC signaling including time information. To this end, the RAN may adjust the periodicity of SIB transmission or the periodicity of timing advance measurement using RRC.

In step 5, the AMF transmits the current 5GS sync information to the PCF. The 5GS sync information may include AS sync, accuracy1, time1, and coverage1 information.

In step 5a, the PCF forwards the current 5GS sync information to the TSCTSF. The 5GS sync information may include AS sync, accuracy1, time1, and coverage1 information.

In step 6, the AF may request, through the NEF, the TSCTSF to provide a 5GS synchronization service. This request may include UE, AS Sync, accuracy2, time2, coverage2, and priority information. UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”. Priority represents the scheme for handling the case where the subscriber information-based 5GS sync method and the AF request-based 5GS sync method are applied simultaneously.

In step 7, the TSCTSF requests the UDM to transmit subscription data for the corresponding UE.

In step 7a, the UDM may include AF sync AS sync allowed in the response. AF sync AS sync allowed indicates whether the corresponding UE can receive the AS sync service based on an AF request. The UDM may also include accuracy1, time1, and coverage1 information in the response, in which case steps 5 and 5a may be skipped.

In step 7b, the TSCTSF receives subscription data for the corresponding UE from the UDM. The subscription data may include AF sync AS sync allowed. The subscription data may also include accuracy1, time1, and coverage1 information, in which case steps 5 and 5a may be skipped.

In step 8, after determining whether the AS sync service is available in step 7b, the TSCTSF may check accuracy1 and 2, time1 and 2, and coverage1 and 2 information according to priority to derive updated accuracy, updated time, and updated coverage information as described in FIG. 3, and check AS sync conditions based on this. The TSCTSF may derive an updated synchronization error budget that is mapped to updated accuracy. The TSCTSF determines whether the 5GS can currently support the TSCTSF and whether the current time satisfies the validity time condition of updated time. The TSCTSF determines whether the location of the UE satisfies an updated coverage condition.

In step 9, the TSCTSF transmits a 5GS sync request to the PCF. The 5GS sync request may include UE, AS Sync, updated accuracy, updated time, and updated coverage information.

In step 10, the PCF forwards the 5GS sync request to the AMF. The 5GS sync request may include UE, AS Sync, updated accuracy, updated time, and updated coverage information.

In step 11, the AMF may check AS sync conditions based on updated accuracy, updated time, and updated coverage information. The AMF may derive an updated synchronization error budget that is mapped to updated accuracy. The AMF determines whether the 5GS can currently support the AMF determines whether the current time satisfies the validity time condition of updated time. The AMF determines whether the location of the UE satisfies an updated coverage condition.

In step 12, the AMF may request AS sync by transmitting an N2 message to the RAN. The N2 message may include AS time distribution configuration and updated synchronization error budget based on Accuracy.

In step 13, the RAN can support time synchronization between UEs by broadcasting an SIB containing time information or by RRC (radio resource control) signaling including time information according to the updated synchronization error budget based on accuracy. To this end, the RAN may update the periodicity of SIB transmission or the periodicity of timing advance measurement using RRC.

In step 14, the AMF transmits the applied 5GS Sync-related information to the TSCTSF via the PCF. The 5GS sync-related information may include UE, AS sync, updated accuracy, updated time, and updated coverage information. If the information does not match the originally requested requirements, steps 8 to 12 may be repeated to turn off 5GS Sync.

In step 15, the TSCTSF forwards the applied 5GS Sync-related information to the AF via the NEF. The 5GS sync-related information may include UE, AS sync, updated accuracy, updated time, and updated coverage information. If the information does not match the originally requested requirements, steps 5 to 12 may be repeated to turn off 5GS Sync.

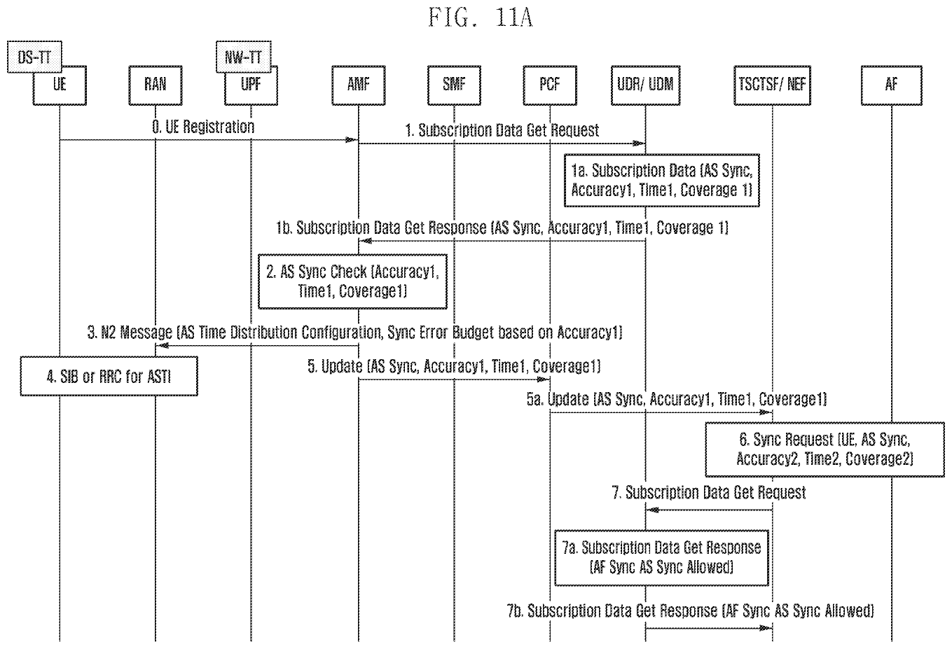

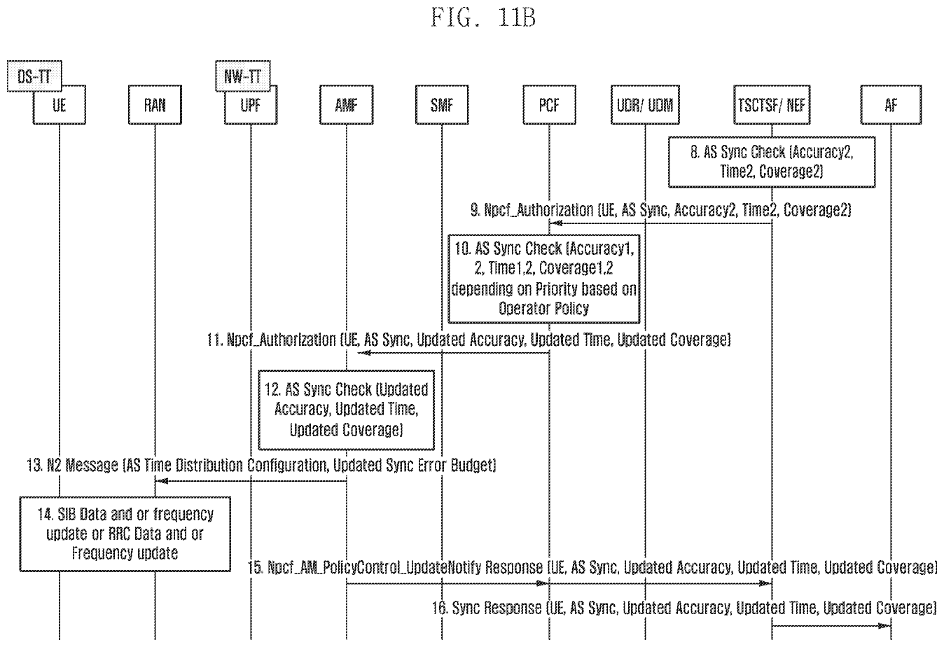

FIGS. 11A and 11B illustrate a scheme for the PCF to determine whether to refer to subscriber information or AF request according to a priority when the priority is specified by operator settings.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, and coverage1 information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”. If there is a change in the conditions of UDM data, this is notified to the AMF, and the procedure is repeated from step 1b.

In step 1b, the AMF receives subscription data from the UDM. AS Sync, accuracy1, time1, and coverage1 information may be included in the subscription data.

In step 2, the AMF may check AS sync conditions by checking accuracy1, time1, and coverage1 information received in step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. Here, AS time distribution configuration and synchronization error budget based on accuracy1 may be included in the N2 message.

In step 4, the RAN can support time synchronization between UEs by broadcasting an SIB containing time information or by RRC (radio resource control) signaling including time information. To this end, the RAN may adjust the periodicity of SIB transmission or the periodicity of timing advance measurement using RRC.

In step 5, the AMF transmits the current 5GS sync information to the PCF. The 5GS sync information may include AS Sync, accuracy1, time1, and coverage1 information.

In step 5a, the PCF forwards the current 5GS sync information to the TSCTSF. The 5GS sync information may include AS sync, accuracy1, time1, and coverage1 information.

In step 6, the AF may request, through the NEF, the TSCTSF to provide a 5GS synchronization service. This request may include UE, AS sync, accuracy2, time2, and coverage2 information. UE represents a target UE to which a 5GS synchronization service is to be provided and may indicate one or multiple UEs. AS Sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”.

In step 7, the TSCTSF requests the UDM to transmit subscription data for the corresponding UE.

In step 7a, the UDM may include AF sync AS sync allowed in the response. AF sync AS sync allowed indicates whether the corresponding UE can receive the AS sync service based on an AF request. The UDM may also include accuracy1, time1, and coverage1 information in the response, in which case steps 5 and 5a may be skipped.

In step 7b, the TSCTSF receives subscription data for the corresponding UE from the UDM. The subscription data may include AF sync AS sync allowed. The subscription data may also include accuracy1, time1, and coverage1 information, in which case steps 5 and 5a may be skipped.

In step 8, after determining whether the AS sync service is available in step 7b, the TSCTSF may check AS sync conditions by checking accuracy2, time2, and coverage2 information received In step 6. The TSCTSF may derive a synchronization error budget that is mapped to accuracy2. The TSCTSF determines whether the 5GS can currently support the TSCTSF and whether the current time satisfies the validity time condition of time2. The TSCTSF determines whether the location of the UE satisfies a coverage2 condition.

In step 9, the TSCTSF transmits a 5GS sync request to the PCF. The 5GS sync request may include UE, AS Sync, accuracy2, time2, and coverage2 information.

In step 10, the PCF may check accuracy1 and 2, time1 and 2, and coverage1 and 2 according to priority based on operator policy to derive updated accuracy, updated time, and updated coverage information as described in FIG. 3, and check AS sync conditions based on this. The TSCTSF may derive an updated synchronization error budget that is mapped to updated accuracy. The TSCTSF determines whether the 5GS can currently support the TSCTSF and whether the current time satisfies the validity time condition of updated time. The TSCTSF determines whether the location of the UE satisfies an updated coverage condition. Priority based on operator policy is set by the operator and represents the scheme for handling the case where the subscriber information-based 5GS sync method and the AF request-based 5GS sync method are applied simultaneously. In this case, priority based on operator policy may have been set in advance by the operator in the PCF.

In step 11, the PCF transmits a 5GS sync request to the AMF. The 5GS sync request may include UE, AS sync, updated accuracy, updated time, and updated coverage information.

In step 12, the AMF may check AS sync conditions based on updated accuracy, updated time, and updated coverage information. The AMF may derive an updated synchronization error budget that is mapped to updated accuracy information. The AMF determines whether the 5GS can currently support the AMF and whether the current time satisfies the validity time condition of updated time. The AMF determines whether the location of the UE satisfies an updated coverage condition.

In step 13, the AMF may request AS sync by transmitting an N2 message to the RAN. The N2 message may include AS time distribution configuration and updated synchronization error budget based on accuracy.

In step 14, the RAN can support time synchronization between UEs by broadcasting an SIB containing time information or by RRC signaling including time information according to the updated synchronization error budget based on accuracy. To this end, the RAN may update the periodicity of SIB transmission or the periodicity of timing advance measurement using RRC.

In step 15, the AMF transmits the applied 5GS sync-related information to the TSCTSF via the PCF. The 5GS sync-related information may include UE, AS sync, updated accuracy, updated time, and updated coverage information. If the information does not match the originally requested requirements, steps 8 to 12 may be repeated to turn off 5GS sync.

In step 16, the TSCTSF forwards the applied 5GS sync-related information to the AF via the NEF. The 5GS sync-related information may include UE, AS sync, updated accuracy, updated time, and updated coverage information. If the information does not match the originally requested requirements, steps 5 to 12 may be repeated to turn off 5GS Sync.

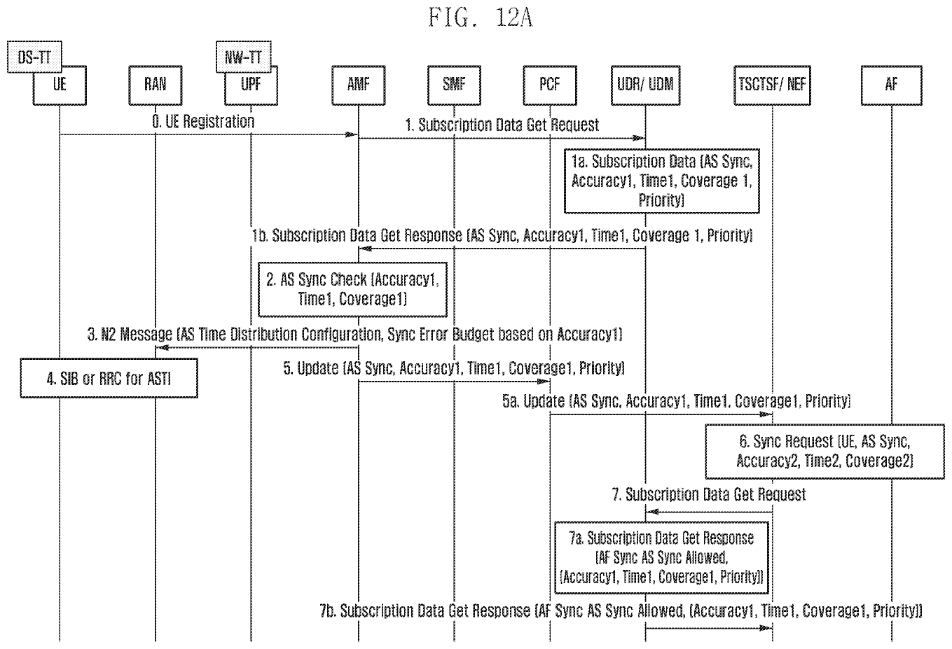

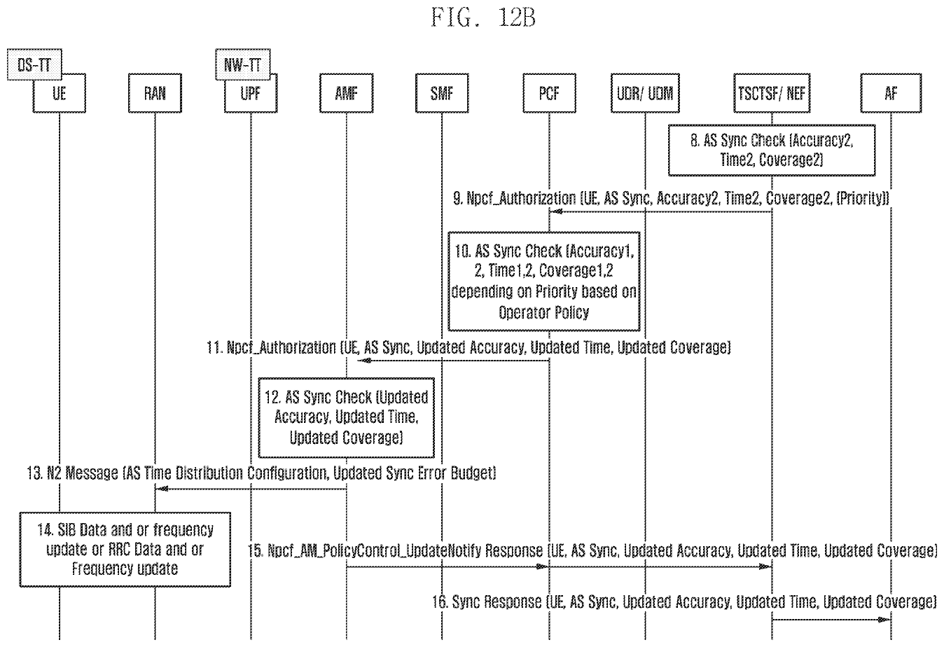

FIGS. 12A and 12B illustrate a scheme for the PCF to determine whether to refer to subscriber information or AF request according to a priority when a priority parameter is included in subscription data, according to an embodiment.

In step 0, the UE transmits a registration request message to the AMF.

In step 1, the AMF transmits a request to the UDM to retrieve subscription data.

In step 1a, the data in the UDM is checked. This data may include AS Sync, accuracy1, time1, coverage1, and priority information. An AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”. Priority represents the scheme for handling the case where the subscriber information-based 5GS sync method and the AF request-based 5GS sync method are applied simultaneously. If there is a change in the conditions of UDM data, this is notified to the AMF, and the procedure is repeated from step 1b.

In step 1b, the AMF receives subscription data from the UDM. AS sync, accuracy1, time1, coverage1, and priority information may be included in the subscription data.

In step 2, the AMF may check AS sync conditions by checking accuracy1, time1, and coverage1 information received In step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. Here, AS time distribution configuration and synchronization error budget based on accuracy1 may be included in the N2 message.

In step 4, the RAN can support time synchronization between UEs by broadcasting an SIB containing time information or by RRC (radio resource control) signaling including time information. To this end, the RAN may adjust the periodicity of SIB transmission or the periodicity of timing advance measurement using RRC.

In step 5, the AMF transmits the current 5GS sync information to the PCF. The 5GS sync information may include AS sync, accuracy1, time1, coverage1, and priority information.

In step 5a, the PCF forwards the current 5GS sync information to the TSCTSF. The 5GS sync information may include AS sync, accuracy1, time1, coverage1, and priority information.

In step 6, the AF may request, through the NEF, the TSCTSF to provide a 5GS synchronization service. This request may include UE, AS sync, accuracy2, time2, and coverage2 information. UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS Sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”. In step 7, the TSCTSF requests the UDM to transmit subscription data for the corresponding UE.

In step 7a, the UDM may include AF sync AS sync allowed in the response. AF sync AS sync allowed indicates whether the corresponding UE can receive the AS sync service based on an AF request. The UDM may also include accuracy1, time1, coverage1, and priority information in the response, in which case steps 5 and 5a may be skipped.

In step 7b, the TSCTSF receives subscription data for the corresponding UE from the UDM. The subscription data may include AF sync AS sync allowed. The subscription data may also include accuracy1, time1, coverage1, and priority information, in which case steps 5 and 5a may be skipped.

In step 8, after determining whether the AS sync service is available In step 7b, the TSCTSF may check AS sync conditions by checking accuracy2, time2, and coverage2 information received In step 6. The TSCTSF may derive a synchronization error budget that is mapped to accuracy2. The TSCTSF determines whether the 5GS can currently support it. Also, the TS CTSF determines whether the current time satisfies the validity time condition of time2. The TSCTSF determines whether the location of the UE satisfies a coverage2 condition.

In step 9, the TSCTSF transmits a 5GS sync request to the PCF. The 5GS sync request may include UE, AS sync, accuracy2, time2, coverage2, and priority information.

In step 10, the PCF may check accuracy1 and 2, time1 and 2, and coverage1 and 2 according to priority to derive updated accuracy, updated time, and updated coverage information as described in FIG. 3, and check AS sync conditions based on this. The TSCTSF may derive an updated synchronization error budget that is mapped to updated accuracy. The TSCTSF determines whether the 5GS can currently support the TSCTSF and whether the current time satisfies the validity time condition of updated time. The TSCTSF determines whether the location of the UE satisfies an updated coverage condition. In this case, priority based on operator policy may be undelivered from the PCF In step 5a but may have been set in advance by the operator in the TSCTSF.

In step 11, the PCF transmits a 5GS sync request to the AMF. The 5GS sync request may include UE, AS sync, updated accuracy, updated time, and updated coverage information.

In step 12, the AMF may check AS sync conditions based on updated accuracy, updated time, and updated coverage information. The AMF may derive an updated synchronization error budget that is mapped to updated accuracy. The AMF determines whether the 5GS can currently support the AMF and whether the current time satisfies the validity time condition of updated time. The AMF determines whether the location of the UE satisfies an updated coverage condition.

In step 13, the AMF may request AS sync by transmitting an N2 message to the RAN. The N2 message may include AS time distribution configuration and updated synchronization error budget based on accuracy.

In step 14, the RAN can support time synchronization between UEs by broadcasting an SIB containing time information or by RRC (radio resource control) signaling including time information according to the updated synchronization error budget based on accuracy. To this end, the RAN may update the periodicity of SIB transmission or the periodicity of timing advance measurement using RRC.

In step 15, the AMF transmits the applied 5GS sync-related information to the TSCTSF via the PCF. The 5GS sync-related information may include UE, AS sync, updated accuracy, updated time, and updated coverage information. If the information does not match the originally requested requirements, steps 8 to 12 may be repeated to turn off 5GS Sync.

In step 16, the TSCTSF forwards the applied 5GS Sync-related information to the AF via the NEF. The 5GS sync-related information may include UE, AS sync, updated accuracy, updated time, and updated coverage information. If the information does not match the originally requested requirements, steps 5 to 12 may be repeated to turn off 5GS Sync.

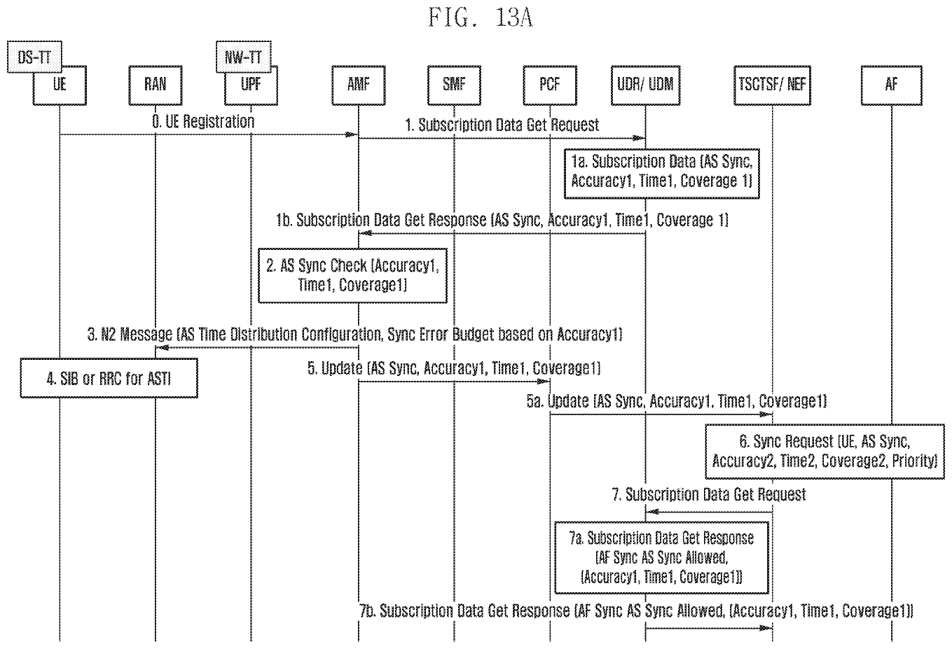

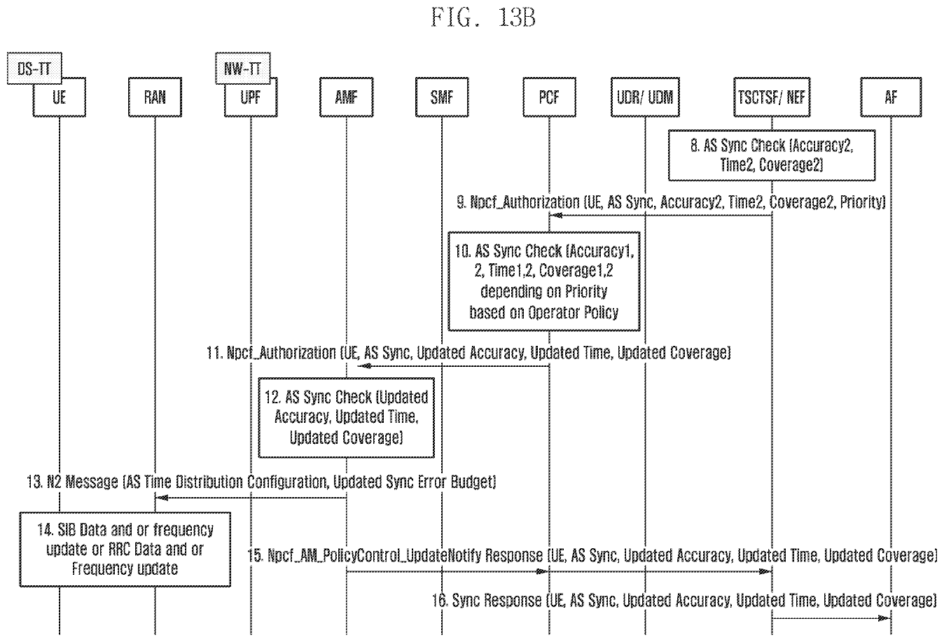

FIGS. 13A and 13B illustrate a scheme for the PCF to determine whether to refer to subscriber information or AF request according to a priority when the priority is specified by AF provided parameters, according to an embodiment.

In step 0, the UE transmits a registration request message to the AMF.

In step 1, the AMF transmits a request to the UDM to retrieve subscription data.

In step 1a, the data in the UDM is checked. This data may include AS sync, accuracy1, time1, and coverage1 information. AS sync indicates whether an AS synchronization service is supported, and accuracy1 indicates the accuracy required to support AS sync. time1 indicates the validity time condition to support AS sync and is represented as a combination of one or more start times and stop times. For a time1 condition, its validity can be expressed as “on” within one start time and stop time combination, and as “off” otherwise. coverage1 represents a coverage condition to support AS sync and is expressed as a TA list or cell list. The case where a coverage condition is satisfied may be expressed as “in”, and when a coverage condition is not satisfied may be expressed as “out”. If there is a change in the conditions of UDM data, this is notified to the AMF, and the procedure is repeated from step 1b.

In step 1b, the AMF receives subscription data from the UDM. AS Sync, accuracy1, time1, and coverage1 information may be included.

In step 2, the AMF may check AS sync conditions by checking accuracy1, time1, and coverage1 information received In step 1b. The AMF may derive a synchronization error budget that is mapped to accuracy1. The AMF determines whether the 5GS can currently support the AMF and whether the current time satisfies the validity time condition of time1. The AMF determines whether the location of the UE satisfies a coverage1 condition.

In step 3, the AMF may request AS sync by transmitting an N2 message to the RAN. Here, AS time distribution configuration and synchronization error budget based on accuracy1 may be included in the N2 message.

In step 4, the RAN can support time synchronization between UEs by broadcasting an SIB containing time information or by RRC signaling including time information. To this end, the RAN may adjust the periodicity of SIB transmission or the periodicity of timing advance measurement using RRC.

In step 5, the AMF transmits the current 5GS sync information to the PCF. The 5GS sync information may include AS sync, accuracy1, time1, and coverage1 information.

In step 5a, the PCF forwards the current 5GS sync information to the TSCTSF. The 5GS sync information may include AS sync, accuracy1, time1, and coverage1 information.

In step 6, the AF may request, through the NEF, the TSCTSF to provide a 5GS synchronization service. This request may include UE, AS sync, accuracy2, time2, coverage2, and priority information. The UE represents a target UE to which a 5GS synchronization service is to be provided and may indicate one or multiple UEs. AS sync indicates whether the AS sync service is supported, and accuracy2 indicates the accuracy required to support AS sync. time2 represents the validity time condition to support AS sync and is represented as a combination of one or more start times and stop times. For a time2 condition, its validity can be expressed as “on” within one start time and stop time combination, and as “off” otherwise. coverage2 represents a coverage condition to support AS sync and is expressed as a TA list or cell list. The case where a coverage condition is satisfied may be expressed as “in”, and when a coverage condition is not satisfied may be expressed as “out”. Priority represents the scheme for handling the case where the subscriber information-based 5GS sync method and the AF request-based 5GS sync method are applied simultaneously.

In step 7, the TSCTSF requests the UDM to transmit subscription data for the corresponding UE.

In step 7a, the UDM may include AF sync AS sync allowed in the response. AF sync AS sync allowed indicates whether the corresponding UE can receive the AS sync service based on an AF request. The UDM may also include accuracy1, time1, and coverage1 information in the response, in which case steps 5 and 5a may be skipped.

In step 7b, the TSCTSF receives subscription data for the corresponding UE from the UDM. The subscription data may include AF sync AS sync allowed. The subscription data may also include accuracy1, time1, and coverage1 information, in which case steps 5 and 5a may be skipped.

In step 8, after determining whether the AS sync service is available In step 7b, the TSCTSF may check AS sync conditions by checking accuracy2, time2, and coverage2 information received In step 6. The TSCTSF may derive a synchronization error budget that is mapped to accuracy2. The TSCTSF determines whether the 5GS can currently support the TSCTSF and whether the current time satisfies the validity time condition of time2. The TSCTSF determines whether the location of the UE satisfies a coverage2 condition.

In step 9, the TSCTSF transmits a 5GS sync request to the PCF. The 5GS sync request may include UE, AS sync, accuracy2, time2, coverage2, and priority information.

In step 10, the PCF checks accuracy1 and 2, time1 and 2, and coverage1 and 2 information according to Priority to derive updated accuracy, updated time, and updated coverage information as described in FIG. 3, and checks AS sync conditions based on this. The TSCTSF may derive an updated synchronization error budget that is mapped to updated accuracy. The TSCTSF determines whether the 5GS can currently support the TSCTSF and whether the current time satisfies the validity time condition of updated time. The TSCTSF determines whether the location of the UE satisfies an updated coverage condition. In this case, priority based on operator policy may be undelivered from the PCF In step 5a but may have been set in advance by the operator in the TSCTSF.

In step 11, the PCF transmits a 5GS sync request to the AMF. The 5GS sync request may include UE, AS sync, updated accuracy, updated time, and updated coverage information.

In step 12, the AMF may check AS sync conditions based on updated accuracy, updated time, and updated coverage. The AMF may derive an updated synchronization error budget that is mapped to updated accuracy information. The AMF determines whether the 5GS can currently support the AMF and whether the current time satisfies the validity time condition of updated time. The AMF determines whether the location of the UE satisfies an updated coverage condition.

In step 13, the AMF may request AS sync by transmitting an N2 message to the RAN. The N2 message may include AS time distribution configuration and updated synchronization error budget based on accuracy.

In step 14, the RAN can support time synchronization between UEs by broadcasting an SIB containing time information or by RRC signaling including time information according to the updated synchronization error budget based on accuracy. To this end, the RAN may update the periodicity of SIB transmission or the periodicity of timing advance measurement using RRC.

In step 15, the AMF transmits the applied 5GS sync-related information to the TSCTSF via the PCF. The 5GS sync-related information may include UE, AS sync, updated accuracy, updated time, and updated coverage information. If the information does not match the originally requested requirements, steps 8 to 12 may be repeated to turn off 5GS Sync.

In step 16, the TSCTSF forwards the applied 5GS sync-related information to the AF via the NEF. The 5GS sync-related information may include UE, AS sync, updated accuracy, updated time, and updated coverage information. If the information does not match the originally requested requirements, steps 5 to 12 may be repeated to turn off 5GS sync.

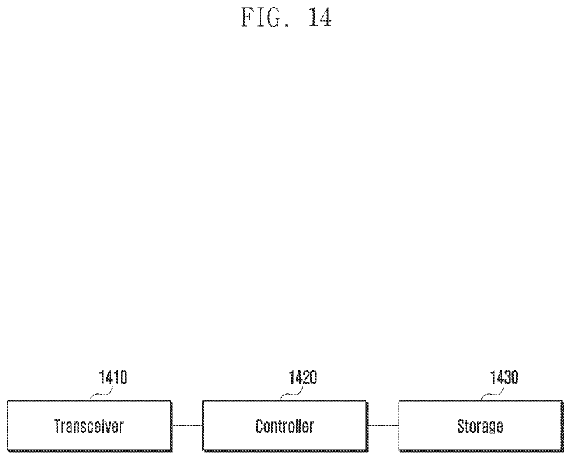

FIG. 14 illustrates the structure of a UE according to an embodiment.

With reference to FIG. 14, the UE may include a transceiver 1410, a controller 1420, and a storage 1430. In the disclosure, the controller may be defined as a circuit, an application-specific integrated circuit, or at least one processor.

The transceiver 1410 can transmit and receive signals to and from other network entities. For example, the transceiver 1410 may receive system information from a base station and may receive a synchronization signal or a reference signal.

The controller 1420 may control the overall operation of the UE according to the embodiments disclosed herein. For example, the controller 1420 can control signal flows between individual blocks so that the UE transmits a registration request message to the AMF, receives SIB or RRC, and performs time synchronization according to an embodiment.

The storage 1430 may store at least one of information transmitted and received through the transceiver 1410 or information generated through the controller 1420. For example, the storage 1430 may store information related to time synchronization obtained through SIB or RRC signaling.

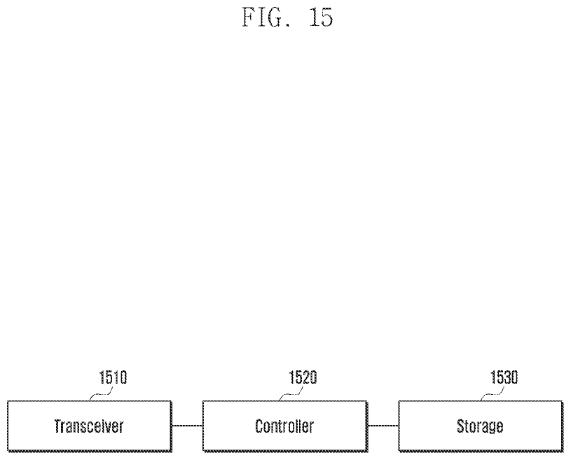

FIG. 15 illustrates the structure of a node, according to an embodiment.

The node shown in FIG. 15 may be configured as one of various types of network entities disclosed herein, and it may be configured as UPF, AMF, SMF, PCF, UDR, UDM, TSCTSF, NEF, or AF, for example.

With reference to FIG. 15, the node may include a transceiver 1510, a controller 1520, and a storage 1530. In the disclosure, the controller may be defined as a circuit, an application-specific integrated circuit, or at least one processor.

The transceiver unit 1510 can transmit and receive signals to and from other network entities. For example, the transceiver 1510 may receive system information from a UE, a base station, or another network entity, and may receive a synchronization signal or a reference signal.

The controller 1520 may control the overall operation of the node according to an embodiment proposed in the disclosure. For example, the controller 1520 may control the node so that it can transmit and receive information for providing a time synchronization service to and from other nodes according to an embodiment disclosed in the disclosure.

The storage unit 1530 may store at least one of information transmitted and received through the transceiver 1510 or information generated through the controller 1520. For example, the storage 1530 may store precedence information for handling multiple time synchronization requests.

It will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for performing functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

The terms “unit”, “module”, or the like used in the embodiments may refer to a software component or a hardware component such as a field programmable gate array (FPGA) or application specific integrated circuit (ASIC) capable of performing a function or an operation. However, “unit” or the like is not limited to hardware or software and may be configured to reside in an addressable storage medium or to drive one or more processors. For example, units or the like may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Components and units may be implemented to drive one or more processors in a device or a secure multimedia card.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory (RAM), a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, a magnetic cassette, or a memory composed of a combination of some or all of these devices. In addition, a plurality of component memories may be included.

In addition, such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that performs an embodiment of the disclosure through an external port. In addition, a separate storage device on a communication network may access the device that performs an embodiment of the disclosure.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a time sensitive communication and time synchronization function (TSCTSF) in a wireless communication system, the method comprising:
receiving, from an application function (AF), a first request message for time synchronization including a first time synchronization error budget for a user equipment (UE);
in response to receiving the first request message from the AF, transmitting to a united data management (UDM), a second request message for time synchronization subscription data of the UE;
receiving, from the UDM, the time synchronization subscription data of the UE including a second time synchronization error budget for the UE;
determining a third time synchronization error budget based on the first time synchronization error budget and the second time synchronization error budget; and
transmitting, to a policy control function (PCF), a third request message for time synchronization including the third time synchronization error budget.

2. The method of claim 1, further comprising:
determining at least one period of start and stop time for the time synchronization of the UE based on first period information and second period information,
wherein the first request message includes the first period information, and
wherein the time synchronization subscription data includes the second period information.

3. The method of claim 1, further comprising:
determining a coverage area for the time synchronization of the UE based on first coverage area information and second coverage area information,
wherein the first request message includes the first coverage area information, and
wherein the time synchronization subscription data includes the second coverage area information.

4. The method of claim 1,
wherein the first request message is received from the AF via a network exposure function (NEF).

5. The method of claim 1,
wherein operator policy information for determining the third time synchronization error budget is preconfigured in the TSCTSF.

6. The method of claim 1, further comprising:
receiving, from the PCF, operator policy information for determining the third time synchronization error budget.

7. The method of claim 1, further comprising:
receiving, from the PCF, a update message for the time synchronization subscription data of the UE.

8. The method of claim 1,
wherein the third time synchronization error budget is determined to one of the first time synchronization error budget or the second time synchronization error budget.

9. A time sensitive communication and time synchronization function (TSCTSF) in a wireless communication system, the TSCTSF comprising:
a transceiver; and
a controller operably coupled with the transceiver and configured to:
receive, from an application function (AF), a first request message for time synchronization including a first time synchronization error budget for a user equipment (UE),
in response to receiving the first request message from the AF, transmit to a united data management (UDM), a second request message for time synchronization subscription data of the UE,
receive, from the UDM, the time synchronization subscription data of the UE including a second time synchronization error budget for the UE,
determine a third time synchronization error budget based on the first time synchronization error budget and the second time synchronization error budget, and
transmit, to a policy control function (PCF), a third request message for time synchronization including the third synchronization error budget.

10. The TSCTSF of claim 9,
wherein the controller is further configured to:
determine at least one period of start and stop time for the time synchronization of the UE based on first period information and second period information,
wherein the first request message includes the first period information, and
wherein the time synchronization subscription data includes the second period information.

11. The TSCTSF of claim 9,
wherein the controller is further configured to:
determine a coverage area for the time synchronization of the UE based on first coverage area information and second coverage area information,
wherein the first request message includes the first coverage information, and
wherein the time synchronization subscription data includes the second coverage information.

12. The TSCTSF of claim 9,
wherein the first request message is received from the AF via a network exposure function (NEF).

13. The TSCTSF of claim 9,
wherein operator policy information for determining the third time synchronization error budget is preconfigured in the TSCTSF.

14. The TSCTSF of claim 9,
wherein the controller is further configured to:
receive, from the PCF, a update message for the time synchronization subscription data of the UE.

15. The TSCTSF of claim 9,
wherein the third time synchronization error budget is determined to one of the first time synchronization error budget or the second time synchronization error budget.
